(19) United States
(12) Patent Application Publication
(10) Pub. No.: US 2009/0150448 A1
(43) Pub. Date: Jun. 11, 2009

(54) METHOD FOR IDENTIFYING AT LEAST TWO SIMILAR WEBPAGES

(76) Inventor: Stephan Lechner, Germering (DE)

Correspondence Address: STAAS & HALSEY LLP, SUITE 700, 1201 NEW YORK AVENUE, N.W., WASHINGTON, DC, 20005, US

(21) Appl. No.: 11/951,458

(22) Filed: Dec. 6, 2007

(30) Foreign Application Priority Data
Dec. 6, 2007 (DE) 10 2006 057 525.3

(51) Int. Cl. G06F 7/04; G06F 17/30

(52) U.S. Cl. 707/200; 707/E17.107

(57) ABSTRACT

Webpages to which different web addresses are assigned and which are stored in the form of web data on different computer systems that are connected to one another via a communications protocol, preferably the Hypertext Transfer Protocol. First, at least the layout, content and/or the graphical elements of a reference webpage are determined in the form of reference data and then a plurality of different webpages are called up by a search and analysis routine and the sets of web data associated with the called-up webpages is compared with the reference data. The webpages that are similar to the reference webpage are identified as a function of the degree of agreement between the web data and the reference data.

### CROSS REFERENCE TO RELATED APPLICATIONS

This application is based on and hereby claims priority to German Application No. 10 2006 057 525.3 filed on Dec. 6, 2006, the contents of which are hereby incorporated by reference.

### BACKGROUND

Using different programming languages such as for example HTML and JAVA it is possible to simulate for example individual control elements of a WWW webpage and thereby deceive the users thereof with regard to the actual status of an internet connection. This method of deception occurring in connection with internet applications is known by the term “phishing” and has been steadily increasing over the last several years.

For this purpose emails with counterfeit sender names, for example, are sent by scammers to users of online services of, for example, banks or financial service providers, by which the users are requested to go to the webpage of the particular bank or financial service provider by clicking a “link” or a “Uniform Resource Locator” (URL) included in the email and log in there by inputting personal access data on the system in order to use the online services. The reason given for this in the email is for example that a “login process” is required in order to update allegedly new functions.

Hidden behind the addresses given in the emails, however, are bogus webpages whose design bears a strikingly close resemblance to the official webpages of the banks or financial service providers in order thereby to convey the impression of an official site and in a fraudulent manner enable the access data of unsuspecting customers to be retrieved.

The problem cited is currently solved by general education in the different media as well as by notices posted on the webpages of the providers, via which notices the users of the webpage or of the applications provided via the webpage are informed that on no account are such emails to be responded to, but that they serve only to acquire personal or confidential data in a fraudulent manner.

In order to close security gaps of this kind in an online service, according to known methods, instead of an authentication by user ID and password, the authentication data is encrypted by a digital certificate.

Furthermore, automated email accounts can be set up which automatically issue a warning to the senders following the reception of phishing emails.

Also conceivable are “blacklist” approaches in which the URLs of the already identified “phishing” websites are listed by the companies affected and made available to customers.

Proceeding from the described related art as the starting point, an aspect is to provide a method for identifying similarities between at least two graphical user interfaces by which “phishing” websites of the aforesaid kind can be identified and suitable measures for suspending their operation can be initiated.

### SUMMARY

The essential aspect of the method is to be seen in the fact that at least the layout, content and/or the graphical elements of a reference webpage are determined in the form of reference data. Next, a plurality of different webpages are called up by a search routine and the web data associated with the called-up webpages is compared with the reference data. Depending on the degree of agreement between the web data and the reference data, the webpages that are similar to the reference webpage are identified. By the method described, webpages exhibiting a strong similarity can be efficiently identified and the associated service providers informed that these are being used for phishing purposes with fraudulent intent. Particularly advantageously, the similarity between two webpages is even used to enable “phishing websites” to be identified proactively instead of their being exposed only through customers who have already suffered harm.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of an example of a computer network having a plurality of computer systems; and

FIG. 2 is a flowchart of an embodiment of the search and analysis routine.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

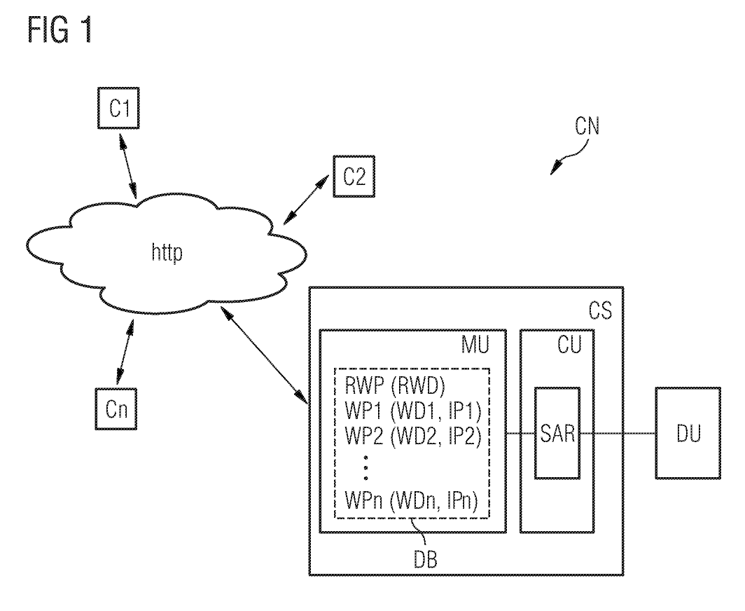

FIG. 1 shows by way of example a computer network CN having a plurality of individual computer systems C1-Cn, CS which are connected to one another in each case via a communications protocol http, preferably the Hypertext Transfer Protocol.

The method is described below for a computer system CS by way of example. The method is, of course, not restricted to the present computer system CS or, as the case may be, computer network CN, but can be used in any other computer systems C1-Cn or other computer networks.

The computer system CS has, by way of example, at least one control unit CU and at least one memory unit MU connected thereto. Also provided connected to the computer system CS is at least one display unit DU, for example a monitor unit for displaying data, in particular web data WD1-WDn. In this arrangement the first to n-th sets of web data WD1-WDn, for example, represent the layout, content and/or the graphical elements of a first to n-th webpage WP1-WPn as well as their functional elements, i.e. are called up to represent the first to n-th webpage WP1-WPn on a web browser application, for example Internet Explorer or Netscape Communicator, and/or are executed in the associated control unit CU of the computer system CS.

For the purpose of calling the first to n-th webpage WP1-WPn via the communications protocol http, a web address IP1-IPn is assigned in each case to a webpage WP1-WPn. The first to n-th webpages WP1-WPn or their web data WD1-WDn can in this case be stored on different computer systems C1-Cn, CS in the computer network CN which are operated for example by different internet service providers.

Thus, for example, a first webpage WP1 stored on a first computer system C1 can be loaded via the communications protocol http and executed by a web browser application running in the computer system CS under consideration or displayed on the computer system's associated display unit DU.

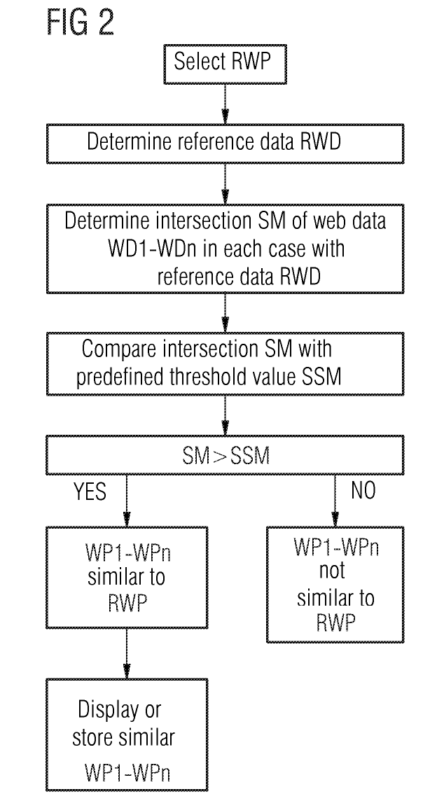

In order to identify at least two similar webpages WP1-WPn stored on the computer systems C1-Cn, CS of the computer network CN, to which similar webpages WP1-WPn different web addresses IP1-IPn are assigned in each case, at least one search and analysis routine SAR is provided in the control unit CU. FIG. 2 shows by way of example a flowchart of a search and analysis routine SAR of this kind.

For this purpose, the webpage requiring protection against “phishing” attacks is first selected as the reference webpage RWP and stored in the memory unit MU of the computer system CS. The URL of a reference webpage RWP of this kind could be for example www.bank-xyz.de.

Next, at least the layout, content and/or the graphical elements of the reference webpage RWP are determined in the form of associated reference data RWD by the search and analysis routine SAR and likewise stored in the memory unit MU.

A plurality of different webpages, in particular the first to n-th webpages WP1-WPn available in the computer network CN, are then called up by the search and analysis routine SAR and the first to n-th sets of web data WD1-WDn associated with these are compared with the previously determined reference data RWD. In this way a search is made for the webpages WP1-WPn that are visually similar to the reference webpage www.bank-xyz.de, for example a webpage www.scammerpage.net. The search for similar webpages WP1-WPn conducted via the search and analysis routine SAR can be performed continuously or at predefined time intervals.

The webpages WP1-WPn that are similar to the reference webpage RWP are identified as a function of the degree of agreement between the web data WD1-WDn and the reference data RWD. For example, the intersection SM of the respective sets of web data WD1-WDn with the reference data RWD can be determined for the purpose of ascertaining the degree of agreement and compared with a threshold value SSM, with the respective webpage WP1-WPn being classified as highly similar to the reference webpage RWP if the threshold value SSM is exceeded.

A webpage www.scammerpage.net that is similar to the reference webpage www.bank-xyz.de is thus identified by the search and analysis routine SAR and displayed to the user of the computer system CS and/or stored in a database DB provided in the memory unit MU.

Following the identification of the similar webpages WP1-WPn, the web addresses IP1-IPn assigned to the webpages are determined by the search and analysis routine SAR. In addition, hosting internet service providers can be identified as a function of the determined web addresses IP1-IPn of the similar webpages WP1-WPn. In a preferred embodiment, a shutdown request, in the form of an email for example, is immediately sent to the identified internet service provider.

The operator of the similar webpage WP1-WPn can also be ascertained on the basis of the identified internet service provider and in addition or alternatively a shutdown request can be sent to the operator. Whether the shutdown has been completed can be verified by a further call-up of the similar webpage WP1-WPn within a predefined time interval by the search and analysis routine SAR.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to an exemplary embodiment. It is to be understood that numerous modifications and variations are possible without thereby departing from the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for identifying at least two similar webpages to which different web addresses are assigned and which are stored as web data on different computer systems that are connected to one another via a Hypertext Transfer Protocol, comprising:
determining at least one of layout, content and graphical elements of a reference webpage as reference data;
calling up different webpages by a search and analysis routine and comparing sets of web data associated with the different webpages that have been called up with the reference data; and
identifying similar webpages that are similar to the reference webpage as a function of degree of agreement between the sets of web data and the reference data.

2. The method as claimed in claim 1, further comprising determining the web addresses of the similar webpages identified by the search and analysis routine.

3. The method as claimed in claim 2, further comprising at least one of displaying the similar webpages to a user and storing the similar webpages in a database.

4. The method as claimed in claim 3, further comprising, to ascertain the degree of agreement, determining an intersection of each of the sets of web data with the reference data and comparing the intersection with a threshold value to classify an associated webpage corresponding to the intersection as highly similar to the reference webpage if the threshold value is exceeded.

5. The method as claimed in claim 4, further comprising identifying an internet service provider of the associated webpage as a function of an associated web address thereof.

6. The method as claimed in claim 5, further comprising sending a shutdown request to the internet service provider of the associated webpage.

7. The method as claimed in claim 6, further comprising ascertaining the operator of the similar webpage via the internet service provider.

8. The method as claimed in claim 7, further comprising sending a shutdown request to the operator of the similar webpage.

9. The method as claimed in claim 8, wherein said determining, calling up, comparing and identifying of the similar webpages are performed continuously or at predefined time intervals.
